(19) United States
(12) Patent Application Publication
(10) Pub. No.: US 2009/0194216 A1
(43) Pub. Date: Aug. 6, 2009

(54) DEPICTING INTERIOR DETAILS IN A THREE-DIMENSIONAL OBJECT

(75) Inventor: Ran HOUMINER, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Solidimension Ltd, Be'erot Itzhak (IL)

(21) Appl. No.: 12/025,061

(22) Filed: Feb. 4, 2008

(51) Int. Cl. B44C 3/02

(52) U.S. Cl. 156/59

(57) ABSTRACT

The present invention provides a method for depicting interior details that are externally visible within to a substantially transparent three-dimensional object that is constructed by the selective attachment of a plurality of sheets one to another so as to form a stack of sheets where each sheet is cut along at least one contour line corresponding to the contour of the respective layer constituted by that particular sheet in the object.

### FIELD AND BACKGROUND OF THE INVENTION

The present invention relates to three-dimensional objects constructed by selective attachment of a plurality of sheets and, in particular, it concerns a method for depicting interior details in a three-dimensional object so as to be visible within the three-dimensional object.

It is known in the art of three-dimensional object building to depict external details of the object by painting or otherwise applying color to the exterior surface of the finished object.

Attempts have been suggested for depicting details on the exterior surface of an object during the construction of the object. One such suggestion relates to those devices that construct the object by solidifying layers of resins or powers. Color is added to the objects constructed using this group of devices by coloring a full layer of the object. This technology is quite different and unsuited for devices that construct the object by selective attachment of a plurality of sheets. Within this group of devices, U.S. Pat. No. 5,015,312 suggests printing exterior or surface details on what will ultimately be the visible exterior surface portion of each sheet prior to the attachment of the sheets one to another.

A field of art in which interior details are depicted is that of anatomical models. However, in these models, the model is made up of several pieces that are either hingedly or otherwise attached one to another and the interior details are actually applied to the outer surface of the individual piece and are visible only when the opaque pieces are separated.

There is therefore a need for a method for depicting interior details in a three-dimensional object so as to be visible within the three-dimensional object.

### SUMMARY OF THE INVENTION

The present invention is a method for depicting interior details in a three-dimensional object so as to be visible within the three-dimensional object.

According to the teachings of the present invention there is provided, a method for depicting interior details in a three-dimensional object constructed by selective attachment of a plurality of sheets so as to form a stack of sheets, each sheet being cut along at least one contour line corresponding to the contour of the respective layer constituted by the sheet in the object, the method comprising: a) constructing the stack with substantially transparent sheets; b) applying a depiction of at least a portion of at least one interior detail of the three-dimensional object on at least one side of at least one of the transparent sheets such that the depiction corresponds to the portion of the detail in the respective layer of the three-dimensional object constituted by the sheet in the object; wherein the interior detail is externally visible within the three-dimensional object.

According to a further teaching of the present invention, the depiction of at least a portion of at least one interior detail of the three-dimensional object is applied on at least one side of at least one of the transparent sheets subsequent to deployment of the at least one of the transparent sheet on the stack

According to a further teaching of the present invention, the depiction is applied by an applicator displaceable along one of the X and the Y axis.

According to a further teaching of the present invention, the depiction is applied by an applicator displaceable along both the X and the Y axis.

According to a further teaching of the present invention, the applicator is an inkjet printing head.

According to a further teaching of the present invention, the applicator is an ink pen.

According to a further teaching of the present invention, the depiction is applied using at least one color.

According to a further teaching of the present invention, the at least one interior detail is configured as a plurality of interior details.

According to a further teaching of the present invention, each of the plurality of interior details in depicted using a different color.

According to a further teaching of the present invention, the depiction of at least a portion of at least one interior detail of the three-dimensional object is applied on at least one side of at least one of the transparent sheets prior to deployment of the at least one of the transparent sheet on the stack.

### BRIEF DESCRIPTION OF THE DRAWINGS

The invention is herein described, by way of example only, with reference to the accompanying drawings, wherein:

FIG. 1 is an isometric view of a three-dimensional object with a depiction of an interior detail visible within the three-dimensional object constructed and operational according to the teachings of the present invention;

FIG. 2 is a schematic isometric view of a step in a first preferred construction process of the three-dimensional object of FIG. 1, in which a first detail segment is applied;

FIG. 3 is a schematic isometric view of a subsequent step in the construction process of the three-dimensional object of FIG. 1, in which a subsequent detail segment is applied;

FIG. 4 is a schematic isometric view of a further subsequent step in the construction process of the three-dimensional object of FIG. 1, in which yet a further subsequent detail segment is applied; and

FIG. 5 is a schematic isometric view of a step in a second preferred construction process of the three-dimensional object of FIG. 1, in which a first detail segment is applied.

### DESCRIPTION OF THE PREFERRED EMBODIMENTS

The present invention is a method for depicting interior details in a three-dimensional object so as to be visible within the three-dimensional object.

The principles and operation of depicting interior details in a three-dimensional object so as to be visible within the three-dimensional object according to the present invention may be better understood with reference to the drawings and the accompanying description.

By way of introduction, the present invention provides a method for depicting interior details that are externally visible within a substantially transparent three-dimensional object that is constructed by the selective attachment of a plurality of sheets one to another so as to form a stack of sheets where each sheet is cut along at least one contour line corresponding to the contour of the respective layer constituted by that particular sheet in the object. An exemplary method and device for forming such a three-dimensional object is disclosed in U.S. patent application Ser. No. 09/581,990, now abandoned.

Interior details are added to the substantially transparent three-dimensional object by depicting at least a portion of at least one interior detail of the three-dimensional object on at least one side of at least one of the transparent sheets that make up the three-dimensional object such that the depiction corresponds to the portion of the detail that lies in that respective layer of the three-dimensional object constituted by that particular sheet in the object.

It will be appreciated that there are a number of suitable methods of applying the depiction of the detail to the surface of the sheets, preferably among them is applying the appropriate portion of the detail on the top sheet of the stack of sheets during the construction process of the three-dimensional object. That is to say, subsequent to deployment of the sheet on the top of the stack. The depiction may be applied to the surface of the sheet using substantially any suitable known technology such as, but not limited to either an ink pen or inkjet head operated along the X and Y axis by a drive mechanism as is known in the art or a laser printing mechanism operated along either the X or the Y axis. The appropriate portion of the depiction may be applied to the surface of the top sheet of the stack prior to or subsequent to the step of cutting the object contour of that particular sheet. An alternative method is pre-printing the appropriate portion of the detail on required sheets using substantially any known printing method and device such as, but not limited to, laser printers and inkjet printers and then deploying the pre-printed sheets such that they will be deployed on the stack in the appropriate order.

It will be readily understood that the depiction may be in color, that more than one interior detail may be depicted, and that each interior detail may be in a different color so as to make them readily distinguishable one from another.

The application of the method of the present invention for depicting interior details in a three-dimensional object to anatomical models results in a realistic model that need not be disassembled in order to view the interior details such as nerves, blood vessels, marrow and fracture lines to mention a few non-limiting examples.

The method of the present invention may also be applied to the field of underground construction in which, by non-limiting example, the proposed route of an underground pipeline or a tunnel may be depicted in a three-dimensional model of the mountain, or portion thereof through which the route passes.

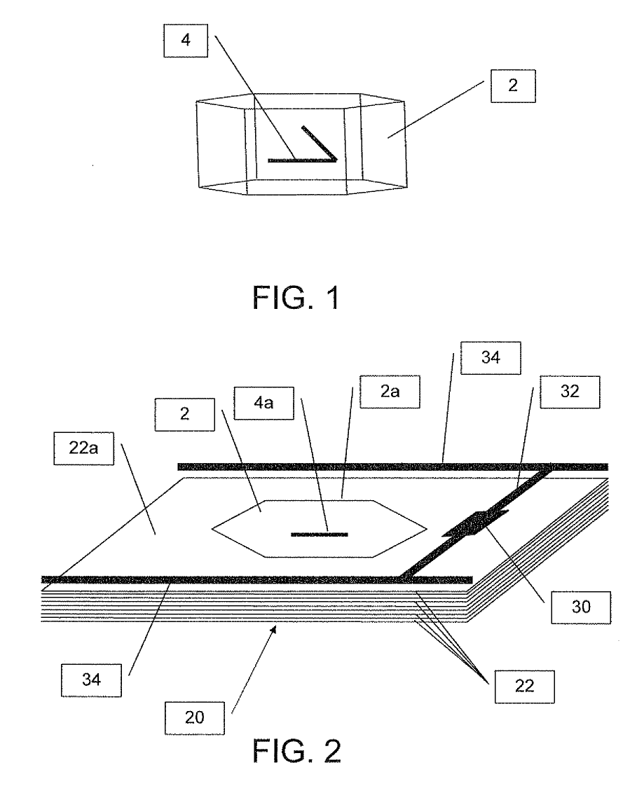

Referring now to the drawings, FIG. 1 illustrates a three-dimensional object 2 in which the interior detail 4 is depicted and is externally visible within three-dimensional object 2.

FIGS. 2-4 illustrate a portion of the construction of the three-dimensional object of FIG. 1 and a first preferred process by which interior detail 4 is depicted.

FIG. 2 illustrates a stack 20 of boned together transparent sheets 22 in which three-dimensional object 2 is being constructed. The exterior contour line 2a of the three-dimensional object 2 is cut in the top sheet 22a of the stack. A depiction of segment 4a of interior detail 4 is applied to the surface of top sheet 22a.

Segment 4a is applied to the surface of top sheet 22a by applicator 30 that is operationally displaceable along the Y axis on guide bar 32 which in turn is displaceable along the X axis on guide bars 34. Therefore, applicator 30 is displaceable along both the X and the Y axis. It will be appreciated, as mentioned above, applicator 30 may be configured as substantially any suitable device for applying, by non-limiting example, ink to the surface of a sheet such as sheet 22a. Therefore, applicator 30 may be configured, by non-limiting example, as an ink pen or an inkjet printing head.

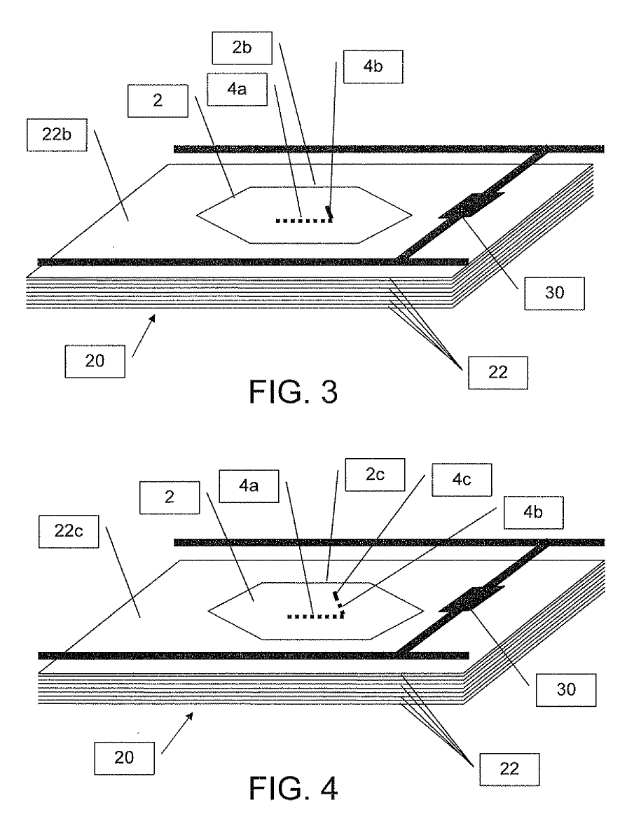

As illustrated in FIG. 3, transparent sheet 22b is deployed as the top sheet of stack 20 such that segment 4a of interior detail 4 is visible through sheet 22b. As in the previous step, exterior contour line 2b of the three-dimensional object 2 is cut in the top sheet 22b of the stack. A depiction of a subsequent segment 4b of interior detail 4 is applied to the surface of top sheet 22b.

FIG. 4 illustrates a further subsequent step in which transparent sheet 22c is deployed as the top sheet of stack 20 such that segments 4a and 4b of interior detail 4 are visible through sheets 22b and 22c. As in the previous step, exterior contour line 2c of the three-dimensional object 2 is cut in the top sheet 22c of the stack. A depiction of a subsequent segment 4c of interior detail 4 is applied to the surface of top sheet 22c.

It will be readily understood that three-dimensional object 2 is completed by adding subsequent sheets, on which no interior detail segments are applied, to the top of stack 22 and unwanted residue is removed from stack 22 leaving three-dimensional object 2.

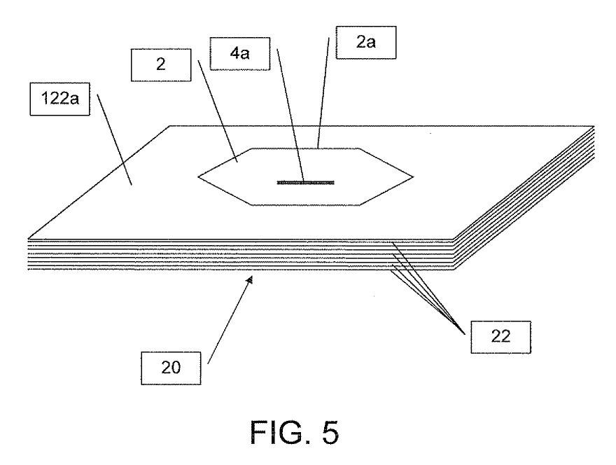

FIG. 5 illustrates a second preferred process by which interior detail 4 is depicted in three-dimensional object 2. The components and construction of three-dimensional object 2 of this embodiment are identical to those of the first embodiment illustrated in FIGS. 2-4, with the exception of the method and device for applying the depiction of segment 4a of interior detail 4. Therefore, similar components are numbered alike and the description is focused on variant features. In this embodiment of the present invention, the depiction of segment 4a of interior detail 4 is pre-applied to the surface of transparent sheet 122a prior to sheet 122a being deployed as the top sheet of stack 20. It will be appreciated that all of the segments of interior detail 4 are likewise pre-applied on transparent sheets which are in turn deployed in the appropriate order on the top of stack 22 so as to complete interior detail 4. It will be readily appreciated that the segments of interior detail 4 may be applied using substantially any known printing method and device such as, but not limited to, laser printers and inkjet printers.

It will be appreciated that the above descriptions are intended only to serve as examples and that many other embodiments are possible within the spirit and the scope of the present invention.

What is claimed is:

1. A method for depicting interior details in a three-dimensional object constructed by selective attachment of a plurality of sheets so as to form a stack of sheets, each sheet being cut along at least one contour line corresponding to the contour of the respective layer constituted by the sheet in the object, the method comprising:
(a) constructing the stack with substantially transparent sheets;
(b) applying a depiction of at least a portion of at least one interior detail of the three-dimensional object on at least one side of at least one of said transparent sheets such that said depiction corresponds to the portion of the detail in the respective layer of the three-dimensional object constituted by the sheet in the object;
wherein said interior detail is externally visible within the three-dimensional object.

2. The method of claim 1, wherein said depiction of at least a portion of at least one interior detail of the three-dimensional object is applied on at least one side of at least one of said transparent sheets subsequent to deployment of said at least one of said transparent sheet on the stack

3. The method of claim 2, wherein said depiction is applied by an applicator displaceable along one of the X and the Y axis.

4. The method of claim 2, wherein said depiction is applied by an applicator displaceable along both the X and the Y axis.

5. The method of claim 4, wherein said applicator is an inkjet printing head.

6. The method of claim 4, wherein said applicator is an ink pen.

7. The method of claim 1, wherein said depiction is applied using at least one color.

8. The method of claim 1, wherein said at least one interior detail is configured as a plurality of interior details.

9. The method of claim 8, wherein each of said plurality of interior details in depicted using a different color.

10. The method of claim 1, wherein said depiction of at least a portion of at least one interior detail of the three-dimensional object is applied on at least one side of at least one of said transparent sheets prior to deployment of said at least one of said transparent sheet on the stack.
